(19) United States
(12) Patent Application Publication
(10) Pub. No.: US 2014/0287714 A1
(43) Pub. Date: Sep. 25, 2014

(54) Distributed Emergency Text Message Architecture

(71) Applicant: TeleCommunication Systems, Inc., Annapolis, MD (US)

(72) Inventors: Roger S. Marshall, Auburn, WA (US); Donald L. Mitchell, Bellevue, WA (US); Thomas Ginter, Bellevue, WA (US); Robin Erkkila, Lafayette, CO (US); Seth Sonenthal, Seattle, WA (US)

(73) Assignee: TeleCommunication Systems, Inc., Annapolis, MD (US)

(21) Appl. No.: 14/220,940

(22) Filed: Mar. 20, 2014

Related U.S. Application Data
(60) Provisional application No. 61/803,668, filed on Mar. 20, 2013.

(51) Int. Cl. H04W 4/12; H04W 40/20

(52) U.S. Cl. CPC H04W 4/12; H04W 40/20
USPC 455/404.2; 455/404.1

(57) ABSTRACT

An internet-protocol (IP) based distributed emergency text message architecture for providing reliable text to 911 services. The distributed emergency text message architecture distributes call routing and media transportation functionalities implemented in a conventional text to 911 solution over the following network entities: an emedia aggregation gateway, an emedia message broker, and an emedia distribution server. An emedia aggregation gateway, emedia message broker, and emedia distribution server each interconnect over an IP network to deliver emergency text messages directly to legacy public safety answering points (PSAPs). Uncoupling emergency services call routing and media transportation functionalities into multiple distributed elements absolves scaling issues associated with the conventional text to 911 solution. An emedia local gateway is preferably positioned on a PSAP in the distributed emergency text message architecture to eliminate the need for a selective router element when routing a teletype (TTY) message to a teletype (TTY) terminal on a legacy PSAP.

The present invention claims priority from U.S. Provisional No. 61/803,668 to Marshall et al., filed Mar. 20, 2013, entitled “Distributed Emergency Text Message Architecture”, the entirety of which is expressly incorporated herein by reference.

### BACKGROUND OF THE INVENTION

1. Field of the Invention

This invention relates generally to telecommunications, and more particularly to public safety, text message (e.g., SMS) to 9-1-1, and emergency text messaging.

2. Background of Related Art

An emergency communications system (e.g. a 911 call system) bridges local government entities and call service providers to route emergency communications requests to emergency dispatch personnel, e.g., a public safety answering point (PSAP), a 911 dispatcher, an emergency call center, etc. The emergency communications system was initially designed to handle landline voice traffic on a public switched telephone network (PSTN) but was later expanded to include wireless call handling capabilities and selective call routing (i.e. the routing of an emergency communications request to a public safety answering point (PSAP) within closest geographic proximity to an originating communications device).

Recently, an overwhelming implementation of text messaging technologies has led many mobile users to assume text messaging may be used to initiate emergency communications requests. However, legacy emergency communications systems do not all have the same capabilities, particularly with respect to reliable handling of emergency text messaging.

FIG. 7 depicts a current text to 911 solution.

In accordance with current technology, an emergency services text control center (TCC) (i.e. ATIS VVTSC-JSMS911 standards group, now published as J-STD-110) 900 on a wireless carrier network 902 receives a text to 911 message in the form of a short message peer to peer (SMPP) protocol message, addressed to short code, ‘911’, from another carrier entity 904. Once received, the text control center (TCC) 900 retrieves a course location for the message originating device, for purposes of performing location-based routing based thereon. The text control center (TCC) 900 then converts the SMPP message addressed to short code, ‘911’, to an appropriate delivery protocol (e.g. teletype (TTY) protocol 908, hypertext transfer protocol with secure sockets layer (SSL)/transport layer security (TLS) (HTTPS) 910, or session initiation protocol (SIP)/message session relay protocol (MSRP) 912) and delivers the message to a public safety answering point (PSAP) 914, 916, 918 via one of three available delivery options. Text to 911 delivery options include: delivery to a teletype (TTP) terminal on a legacy public safety answering point (PSAP) 914, delivery to a secure web browser client on a transitional public safety answering point (PSAP) (i.e. an internet protocol (IP)-enabled public safety answering point (PSAP) with a web browser client) 916, and delivery to an i3/emergency services internet protocol (IP) network 918 for subsequent forwarding to a public safety answering point (PSAP) with next generation 911 (NG911) technology.

In accordance with the conventional technology, a text control center (TCC) 900 routes a text to 911 message to a teletype (TTY) terminal on a legacy public safety answering point (PSAP) 914 by converting the text to 911 message to a teletype (TTY) protocol 908 and routing the text to 911 message through a selective router (SR) 920 to the public safety answering point (PSAP) 914. A legacy public safety answering point (PSAP) 914 is connected to a selective router (SR) 920 via time division multiplexing (TDM) trunks 922.

Conventional text to teletype (TTY) delivery is typically both unreliable and slow, since teletype (TTY) messages transmitted through a selective router 920 connected to time-division multiplexing (TDM) trunks 922 are prone to corruption and transmission delay. Moreover, transmitting text to 911 messages over legacy emergency communication systems via time-division multiplexing (TDM) trunks 922 is costly.

In a text to transitional public safety answering point (PSAP) 916 text to 911 delivery option, a text control center (TCC) 900 converts an SMS-originated request to a hypertext transfer protocol with secure sockets layer (SSL)/transport layer security (TLS) (HTTPS) 910 and then routes the request as a web service through a web browser located on a transitional public safety answering point (PSAP) 916.

Moreover, in a text to i3/emergency services internet protocol (IP) network 918 text to 911 delivery option, a text control center (TCC) 900 converts a text to 911 message to a session initiation protocol (SIP)/message session relay protocol (MSRP) (i.e. an internet protocol (IP)) 912 and then routes the SIP/MSRP message downstream to an i3/emergency services Internet protocol (IP) network 918.

FIG. 8 depicts a conventional text to 911 architecture comprising a large number of network carrier to public safety answering point (PSAP) connections.

As depicted in FIG. 8, the inventors have appreciated that multiple incoming carrier-connections 800a, 800b, 800c, 800d can unfortunately lead to port constraints in the legacy emergency communications system 802. In particular, when a multitude of network carriers 804a, 804b, 804c, 804d deliver TTY text to 911 messages through a single selective router (SR) 920 to a public safety answering point (PSAP) 914 on the legacy emergency communications system 802, selective router (SR) ports 806a, 806b, 806c, 806d may become constrained. In such a scenario, the inventors have appreciated that routing directly to a public safety answering point (PSAP) 914 automatic number identifier (ANI)/automatic location identifier (ALI) controller may be more effective. However, the present inventors have appreciated that ANI/ALI controller ports may too become constrained.

FIG. 9 depicts ubiquity of delivery tools at a transitional public safety answering point (PSAP) in the conventional text to 911 solution.

As depicted in FIG. 9, every network carrier 700a, 700b, 700c, 700d that deploys a unique text control center (TCC) vendor solution 700a, 700b, 700c, 700d, offers a unique web user interface 704a, 704b, 704c, 704d to a transitional public safety answering point (PSAP) 916. Since a number of required web browser interfaces 906a, 906b, 906c, 906d at a transitional public safety answering point (PSAP) 916 must match a number of unique carrier text control center (TCC) combinations 704a, 704b, 704c, 704d supported by that public safety answering point (PSAP) 916, the present inventors have realized that transitional public safety answering points (PSAP) 916a, 916b may eventually be forced to support an unmanageable number of diverse web browser interfaces.

### SUMMARY OF THE INVENTION

An internet protocol (IP)-based, distributed emergency text message architecture for routing and delivery emergency text messages to emergency dispatch personnel (e.g. public safety answering points (PSAPs), 911 call centers, etc.), comprises an emedia aggregation gateway, an emedia message broker, and an emedia distribution server.

In accordance with the principles of the present invention, a distributed emergency text message architecture divides call routing and media transportation functionalities implemented in a conventional text to 911 solution over the following network entities: an emedia aggregation gateway, an emedia message broker, and an emedia distribution server. Each entity supports independent deployment and each entity modularly integrates over an internet protocol (IP) network to route emergency text messages to emergency dispatch personnel.

In accordance with the principles of the present invention, an emedia aggregation gateway in the distributed emergency text message architecture is responsible for receiving text to 911 messages from a wireless carrier entity, converting text to 911 messages to a session initiation protocol (SIP) (i.e. an Internet protocol (IP)), and routing text to 911 messages over an internet protocol (IP) network to an emedia message broker.

In accordance with the principles of the present invention, an emedia message broker is responsible for routing text to 911 messages received from an emedia aggregation gateway over an internet protocol (IP) network to an emedia distribution server on a public safety answering point (PSAP) (preferably a public safety answering point (PSAP) within closest geographic proximity to an SMS originating device).

In accordance with the principles of the present invention, an emedia distribution server in the distributed emergency text message architecture is responsible for receiving text to 911 messages on a public safety answering point (PSAP), converting text to 911 messages from a session initiation protocol (SIP) to an appropriate message delivery protocol, and routing text to 911 messages to an appropriate message recipient entity on the public safety answering point (PSAP).

In accordance with the principles of the present invention, an emedia local gateway is preferably positioned on public safety answering points (PSAPs) in the distributed emergency text message architecture, to eliminate the need for a selective router element when routing a teletype (TTY) message to a teletype (TTY) terminal on a legacy public safety answering point (PSAP). The inventive emedia local gateway enables the distributed emergency text message solution to bypass selective-router based legacy emergency service networks and permits additional local services (e.g. logging) to be performed on public safety answering points (PSAPs).

### BRIEF DESCRIPTION OF THE DRAWINGS

Features and advantages of the present invention will become apparent to those skilled in the art from the following description with reference to the drawings, in which:

FIG. 1 depicts an exemplary distributed emergency text message architecture containing an emedia distribution server and an emedia aggregation gateway, in accordance with the principles of the present invention.

FIG. 2 depicts an exemplary text to 911 message flow on a distributed emergency text message architecture containing an emedia distribution server and an emedia aggregation gateway, in accordance with the principles of the present invention.

FIG. 3 depicts exemplary scaling issues associated with a distributed emergency text message architecture containing an emedia distribution server and an emedia aggregation gateway, in accordance with the principles of the present invention.

FIG. 4 depicts an exemplary distributed emergency text message architecture containing an emedia aggregation gateway, an emedia distribution server, and an emedia message broker, in accordance with the principles of the present invention.

FIG. 5 depicts an exemplary text to 911 message flow on a distributed emergency text message architecture containing an emedia aggregation gateway, an emedia distribution server, and an emedia message broker, in accordance with the principles of the present invention. FIG. 6 depicts an exemplary distributed emergency text message architecture containing an emedia local gateway, in accordance with the principles of the present invention.

FIG. 7 depicts a current text to 911 solution.

FIG. 8 depicts a conventional text to 911 architecture comprising a large number of network carrier to public safety answering point (PSAP) connections.

FIG. 9 depicts ubiquity of delivery tools at a transitional public safety answering point (PSAP) in the conventional text to 911 solution.

### DETAILED DESCRIPTION OF ILLUSTRATIVE EMBODIMENTS

The present invention provides a scalable, reliable method and system to provide emergency 911 text message services. The disclosed embodiments provide an Internet protocol (IP)-based, distributed emergency text message architecture for routing and delivery emergency text messages to emergency dispatch personnel, e.g., public safety answering points (PSAPs), 911 call centers, etc.

The inventive distributed emergency text message architecture distributes call routing and media transportation functionalities used in a conventional text to 911 solution over the following inventive network entities: an emedia aggregation gateway, an emedia message broker, and an emedia distribution server. Each of these inventive network entities supports independent deployment, and each entity modularly integrates over an internet protocol (IP) network to route emergency text messages to emergency dispatch personnel.

The federal communications commission (FCC) has recently required that all wireless carriers begin efforts to support text to 911 services (in addition to standard voice to 911 services). A text to 911 service enables a mobile subscriber to use a text messaging service to initiate emergency service requests to emergency dispatch personnel, e.g., a public safety answering point (PSAPs), a 911 call center, etc. Currently, only a small percentage of jurisdictions fully support text to 911 capabilities, but an increasing number of jurisdictions and public safety answering points (PSAPs) are expected to support text to 911 technology in the upcoming years.

The inventors appreciated that teletype (TTY) equipment is available essentially at all legacy public safety answering points (PSAP) 914, and that upgrades are currently being made to the legacy public safety answering point (PSAP) architecture to provide support for web browser clients and next generation 911 (NG911) technology.

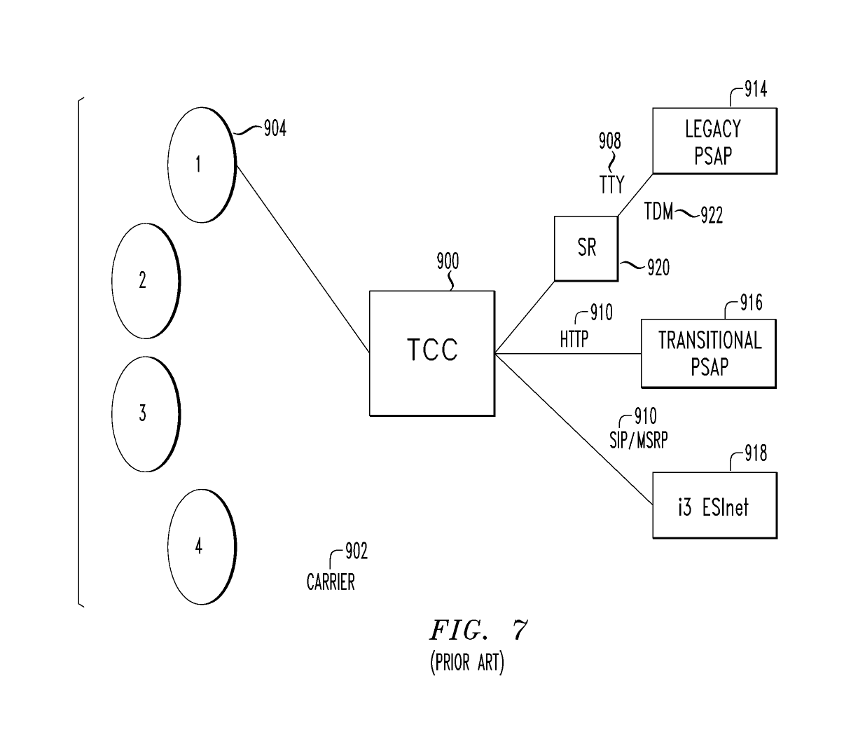

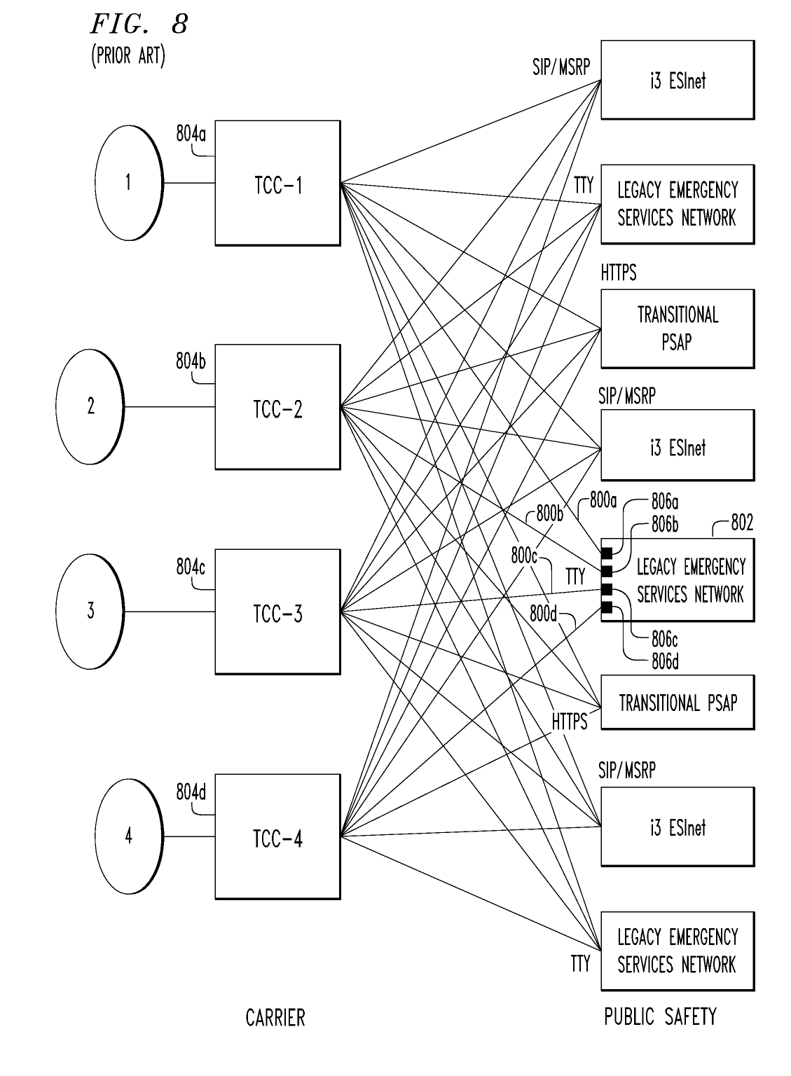

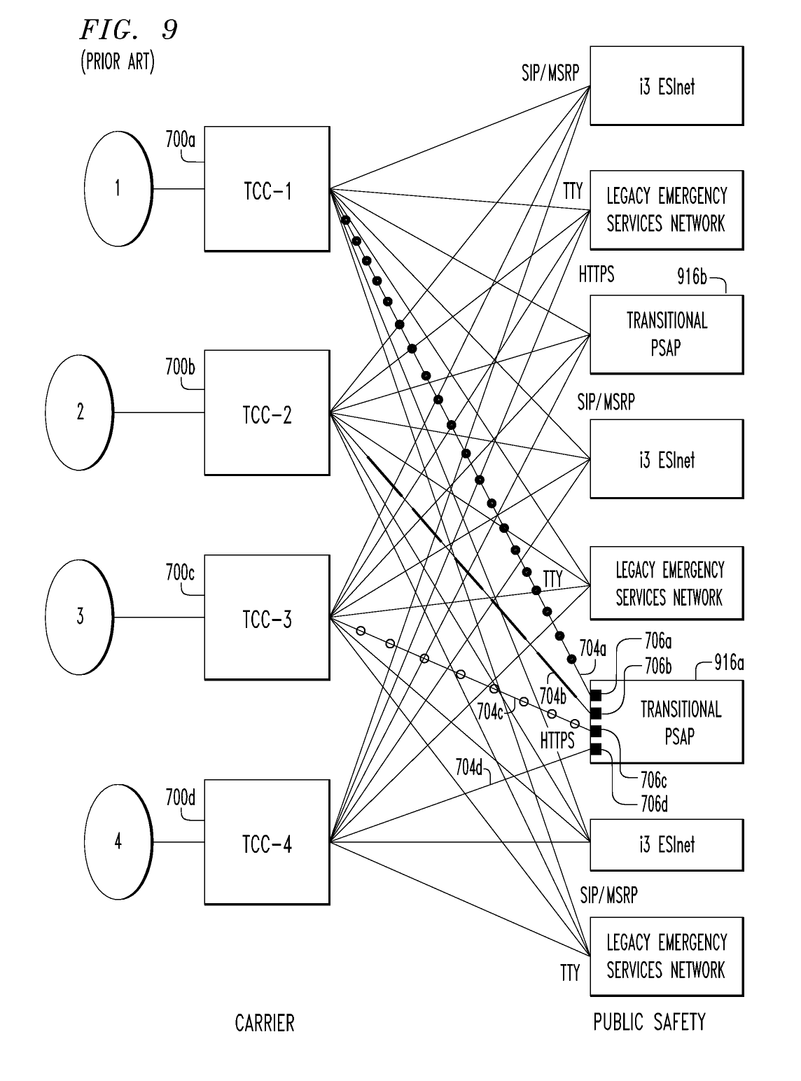

The present inventors have appreciated that the current text to 911 solution (FIG. 7) is likely to encounter scalability issues, and thus provide herein a solution to support a large number of carrier-connections and permits network carriers to deliver text to 911 messages to a multitude of public safety answering points (PSAPs). Moreover, in addition to scaling issues associated with the current text to 911 solution, the present inventors have also appreciated that ubiquity of delivery tools at transitional public safety answering points (PSAPs) may prove problematic as text to 911 services become widely deployed.

In accordance with the principles of the present invention, the inventive distributed emergency text message architecture for routing and delivering emergency text messages to emergency dispatch personnel, comprises an emedia distribution server and an emedia aggregation gateway. An emedia distribution server ensures that transitional public safety answering points (PSAP) are not forced to support an unmanageable number of diverse web browser interfaces as support for text to 911 services expands. In accordance with the principles of the present invention, the inventive emedia distribution server aggregates or ‘normalizes’ disparate web browser interfaces at a transitional public safety answering point (PSAP) 916.

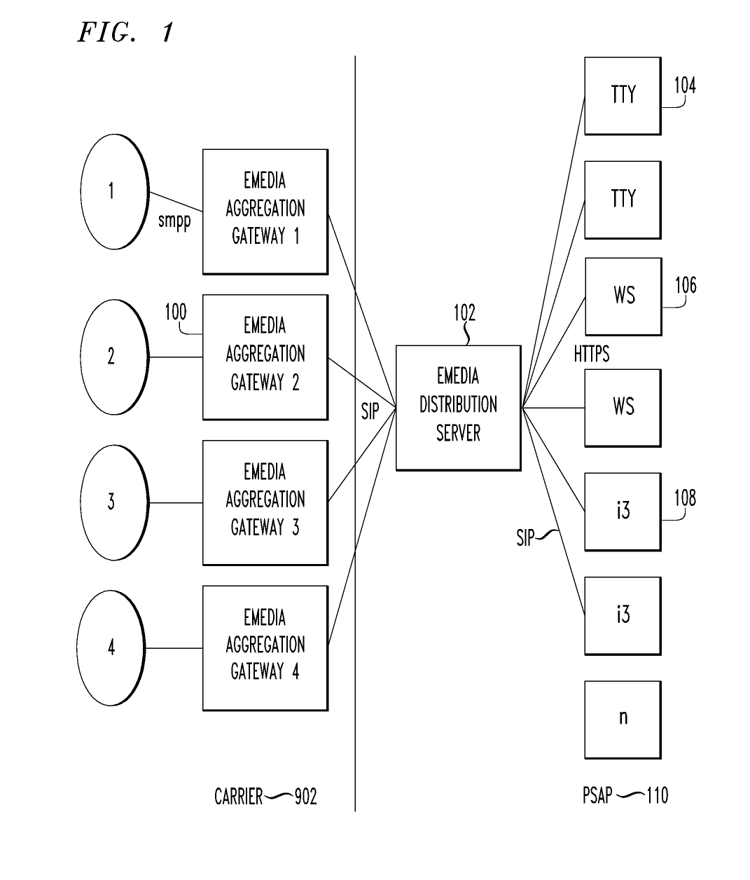

FIG. 1 depicts an exemplary distributed emergency text message architecture comprising an emedia distribution server and an emedia aggregation gateway, in accordance with the principles of the present invention.

As depicted in FIG. 1, the inventive distributed emergency text message architecture distributes functionalities of a conventional emergency services text control center (TCC) over an emedia aggregation gateway 100 and an emedia distribution server 102. In accordance with the principles of the present invention, an emedia aggregation gateway 100 is positioned on a network carrier 902 and acts as an originating text control center (TCC), whereas an emedia distribution server 102 is positioned at a public safety answering point (PSAP) 110 and acts as a terminating text control center (TCC).

As portrayed in FIG. 1, a message recipient entity 104, 106, 108 on a public safety answering point (PSAP) 110 in the distributed emergency text message architecture need maintain only a single connection to an emedia distribution server 102 to receive text to 911 messages. An emedia aggregation gateway 100 and an emedia distribution server 102 interconnect via an internet protocol (IP) network.

In accordance with the principles of the present invention, by uncoupling the functionalities of a text control center (TCC) into multiple network entities, the inventive solution absolves the likelihood that port constraints will affect the distributed text to 911 solution.

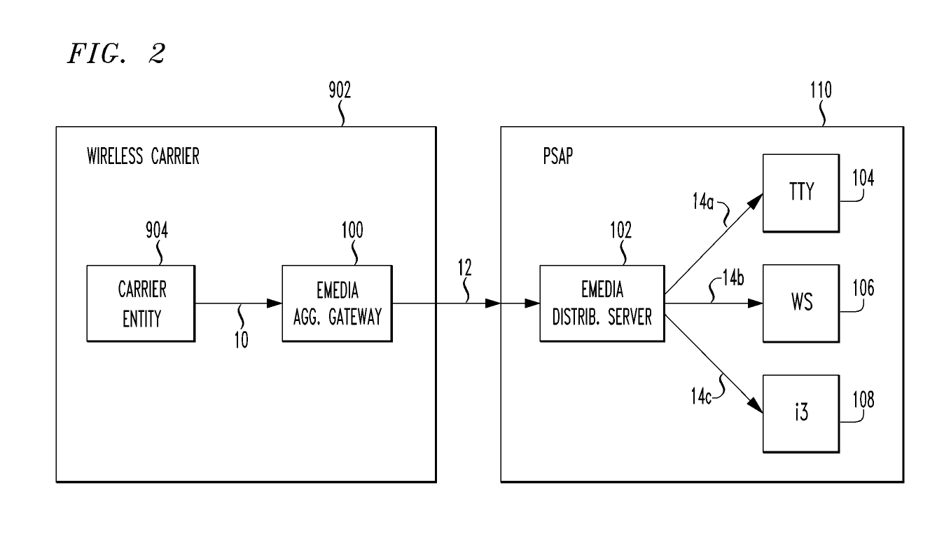

FIG. 2 depicts an exemplary text to 911 message flow on a distributed emergency text message architecture containing an emedia distribution server and an emedia aggregation gateway, in accordance with the principles of the present invention.

In particular, as shown in step 10 of FIG. 2, an emedia aggregation gateway 100 on a wireless carrier network 902 receives a text to 911 message as a short message peer to peer protocol (SMPP) message, addressed to short code, ‘911’, from another carrier entity 904. As shown in step 12, the emedia aggregation gateway 100 then converts the text to 911 message to a SIP/MSRP HELD Deref protocol (i.e. an internet protocol (IP)) and routes the message over an internet protocol (IP) network to an emedia distribution server 102 on a public safety answering point (PSAP) 110. As shown in step 14a, 14b, 14c, the emedia distribution server 102 on the public safety answering point (PSAP) 110 receives the internet protocol (IP) text to 911 message, converts the message to an appropriate delivery protocol, and routes the message to one of: a teletype (TTY) terminal 104 (routed via a teletype (TTY) protocol), a web browser client 106 (routed via an HTTPS protocol), or an emergency services internet protocol (IP) network 108 (routed via an Internet protocol (IP)).

Though a distributed emergency text message architecture comprising an emedia aggregation gateway 100 and an emedia distribution server 102 may absolve potential port constraints on the legacy emergency communications system, the architecture is still prone to scaling issues.

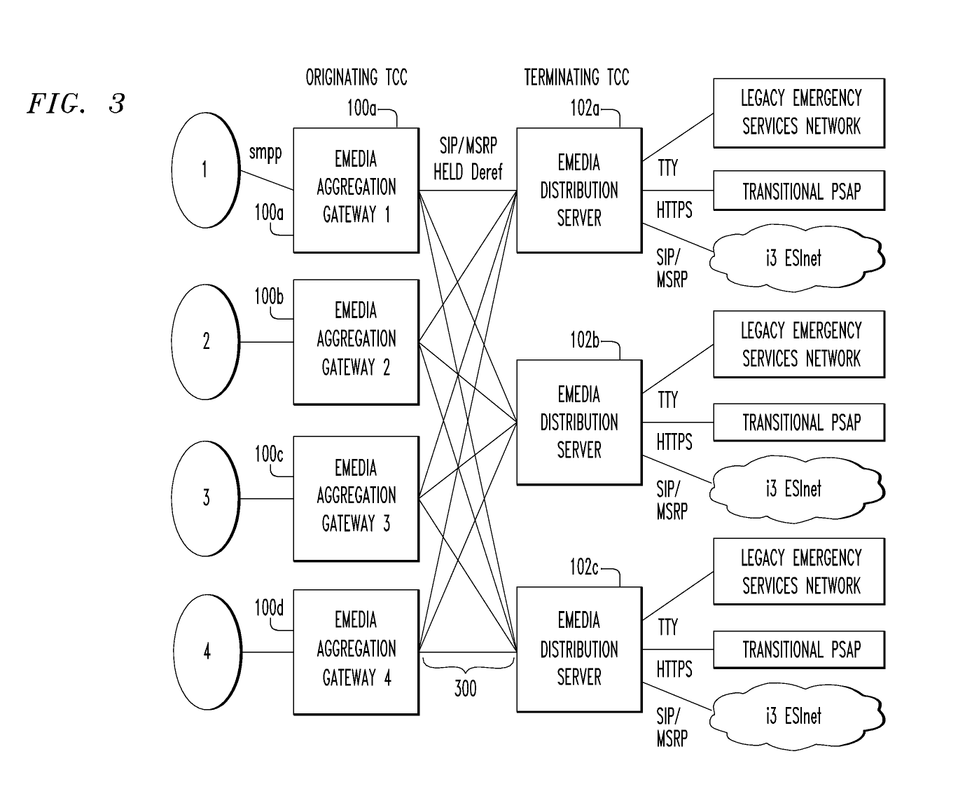

FIG. 3 depicts exemplary scaling issues associated with a distributed emergency text message architecture containing an emedia distribution server and an emedia aggregation gateway, in accordance with the principles of the present invention.

In particular, as nation-wide text to 911 deployment ensues, the number of interfaces between aggregation gateways on supporting carrier networks and emedia distribution servers on supporting public safety answering points (PSAPs) will continue to increase. Unfortunately, an unmanageable number of interfaces between network carrier aggregation gateways 100a, 100b, 100c, 100d and emedia distribution servers 102a, 102b, 102c will result in scaling issues.

In accordance with the principles of the present invention, a distributed emergency text message architecture preferably comprises an emedia message broker to provide an additional level of redirection and thus help mitigate scaling issues. An emedia message broker provides a third level of aggregation between a network carrier aggregation gateway 100 and a message recipient entity 104, 106, 108 on a public safety answering point (PSAP) 110. The inventive emedia message broker cuts down on excess circuit interconnects and text control center (TCC) interconnections on the distributed text to 911 solution.

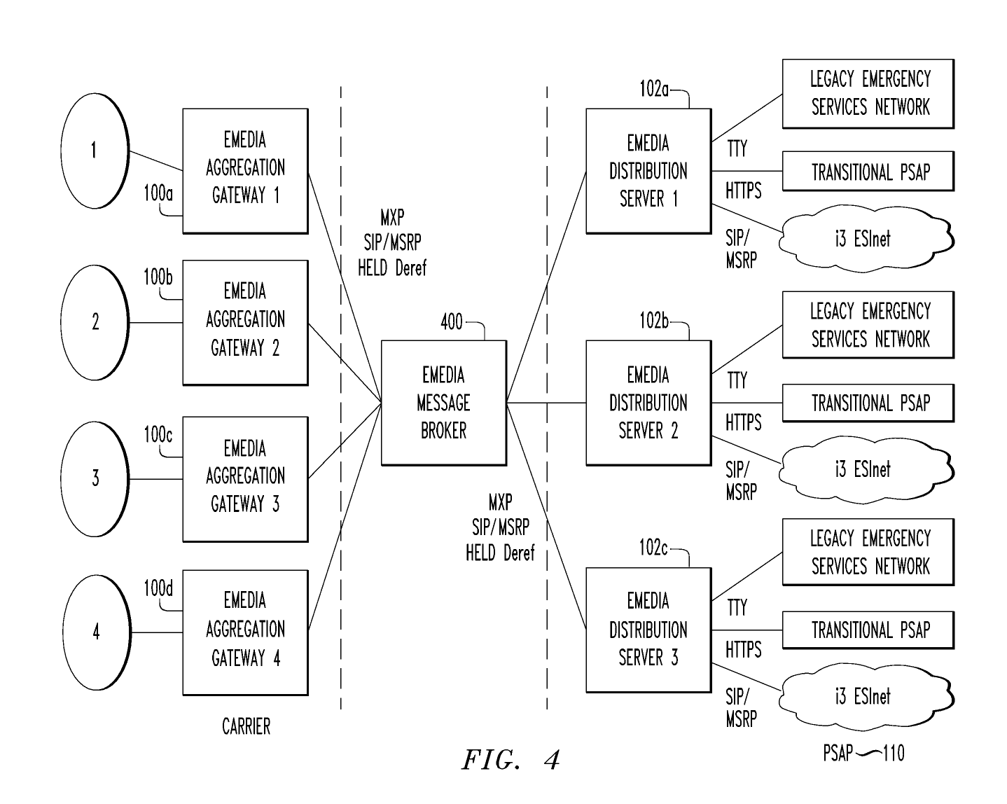

FIG. 4 depicts an exemplary distributed emergency text message architecture containing an emedia aggregation gateway, an emedia distribution server, and an emedia message broker, in accordance with the principles of the present invention.

In particular, as opposed to enabling an aggregation gateway 100a, 100b, 100c, 100d to directly interconnect with an emedia distribution server 102a, 102b, 102c, the inventive distributed emergency text message architecture comprises an emedia message broker 400 to lie between the two entities. By implementing an emedia message broker 400 in the distributed emergency text message architecture, an emedia aggregation gateway 100a, 100b, 100c, 100d need only interconnect with an emedia message broker 400 to transmit text messages to appropriate public safety answering points (PSAPs) 110.

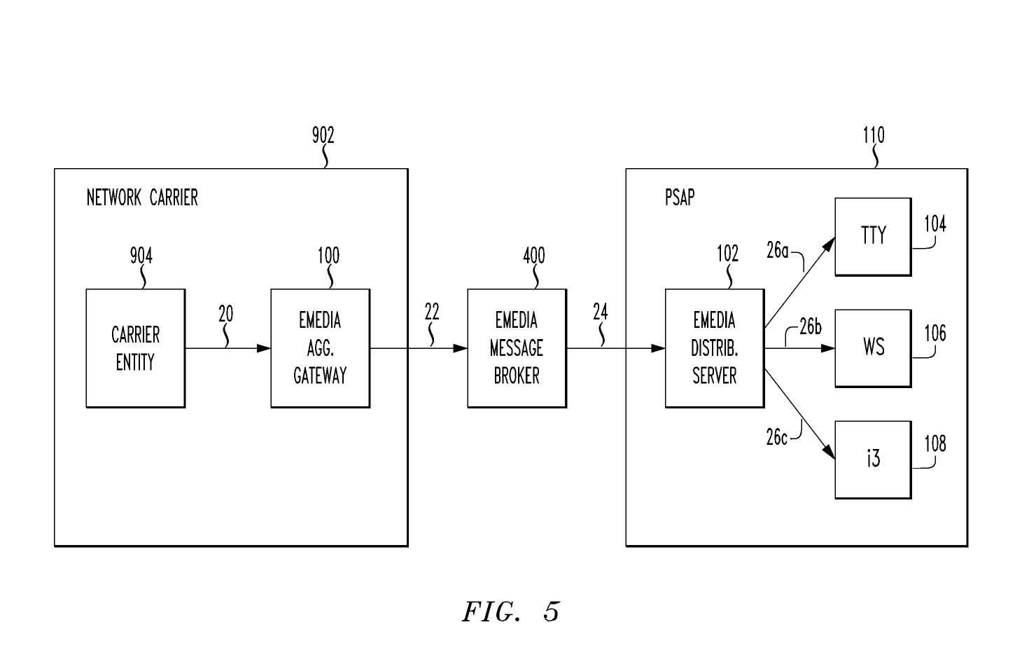

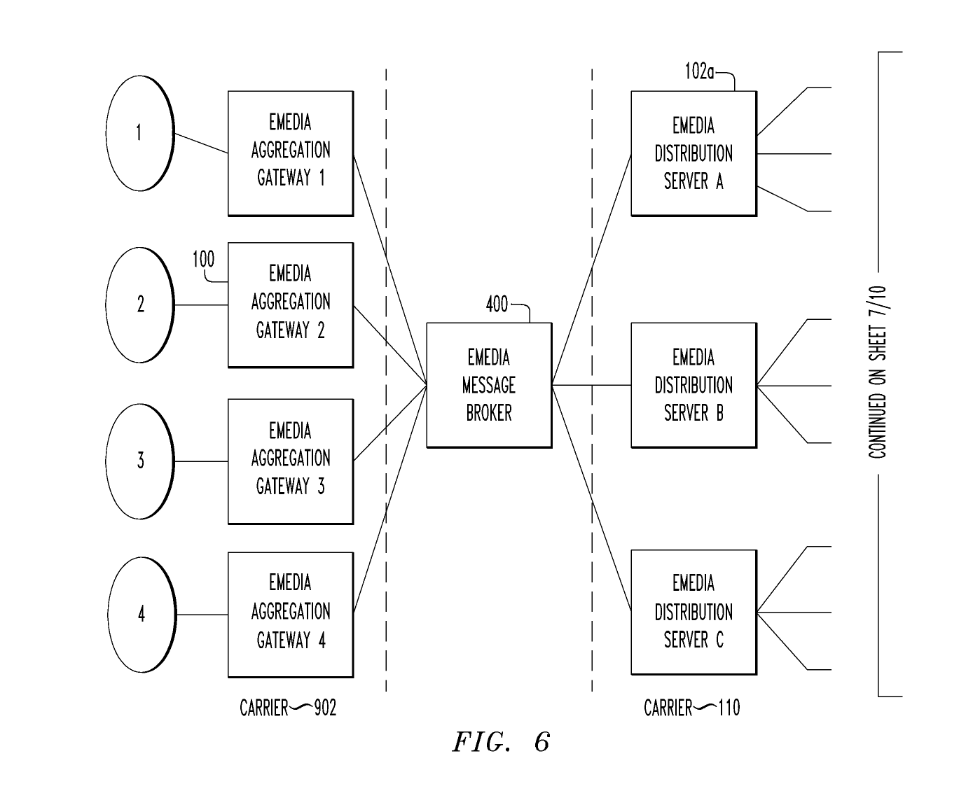

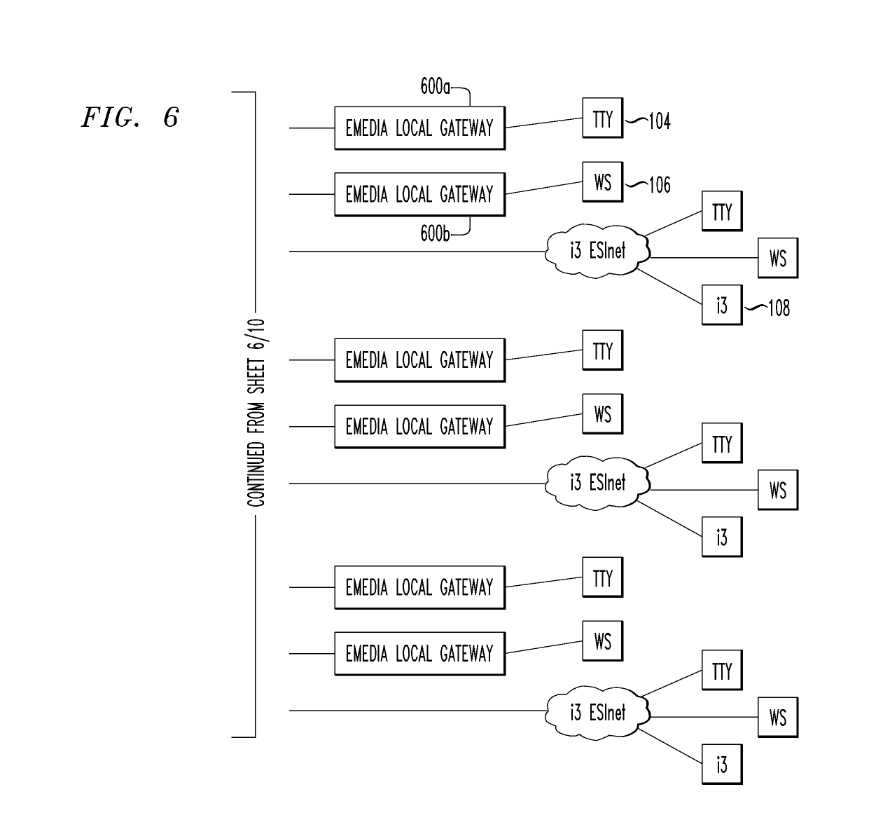

FIG. 5 depicts an exemplary text to 911 message flow on a distributed emergency text message architecture comprising an emedia aggregation gateway, an emedia distribution server, and an emedia message broker, in accordance with the principles of the present invention.

In particular, as portrayed in step 20 of FIG. 5, an emedia aggregation gateway 100 on a serving carrier network 902 receives a text to 911 message from a carrier entity 904 in the form of a short message peer to peer (SMPP) protocol, and then routes the emergency text to 911 message, using a session initiation protocol (SIP), over an internet protocol (IP) network to an emedia message broker 400 (step 22). As shown in step 24, the inventive emedia message broker 400 receives the text to 911 message from the emedia aggregation gateway 100 and routes the text to 911 message to an emedia distribution server 102 on a public safety answering point 110 (preferably a public safety answering point (PSAP) 110 within closest geographic proximity to an originating wireline/wireless calling device). Routing is preferably location-based and performed over an internet protocol (IP) network. As shown in step 26a, 26b, 26c, the emedia distribution server 102 on the public safety answering point (PSAP) 110 receives the text to 911 message, converts the text to 911 message to an appropriate delivery protocol (e.g. teletype (TTY) protocol, HTTPS, or SIP/MSRP) and then routes the message to one of: a teletype (TTY) terminal 104 (routed via a teletype (TTY) protocol), a web browser client 106 (routed via an HTTPS protocol), or an emergency services internet protocol (IP) network 108 (routed via an internet protocol (IP)), depending upon technological capabilities of the public safety answering point (PSAP) 110.

In accordance with the principles of the present invention, an inventive emedia local gateway is also preferably added to public safety answering points (PSAPs) 110 within the inventive distributed emergency text message architecture, to enable emergency text messages to be routed to teletype (TTY) terminals 104 on legacy public safety answering points (PSAPs) without requiring that text messages be sent via a teletype (TTY) protocol over a selective router based emergency services network (i.e. an emergency services network that uses a selective router, connected to various public safety answering points (PSAPs) via time-division multiplexing (TDM) trunks, to determine appropriate public safety answering points (PSAPs) to which to forward emergency communications requests).

FIG. 6 depicts an exemplary distributed emergency text message architecture containing an emedia local gateway, in accordance with the principles of the present invention.

As depicted in FIG. 6, an emedia local gateway 600a, 600b is positioned at a public safety answering point (PSAP) 110 to enable the distributed emergency text message architecture to bypass selective router-based emergency service networks.

Current standards for routing an emergency communications request to a teletype (TTY) terminal 104 on a legacy public safety answering point (PSAP) 914 define only a single selective router 920 positioned between a text control center (TCC) 900 and the public safety answering point (PSAP) 914. This conventional implementation is quite limiting, being that the implementation does not define an owner of the selective router 920. For instance, carriers may want to own their own selective router 920. Moreover, the conventional implementation requires public safety answering points (PSAPs) to sign on to selective routers one by one.

Positioning an emedia local gateway 600a, 600b at a public safety answering point (PSAP) 110 allows the present invention to bypass legacy emergency service networks and permits additional local services (e.g. logging) to be performed on a public safety answering point (PSAP) 110.

The present invention assists implementers of text to 911 services by enabling implementers to: deploy independently (regardless of whether or not other text to 911 elements have yet been implemented), eliminate path reliance on selective routers in the legacy emergency communications system, and reduce circuit (trunk) costs by using low cost IP circuits to provide text to 911 capabilities, as opposed to expensive time-division multiplexing (TDM) trunks.

The inventive solution provides increased monitoring capabilities, permits logging at legacy public safety answering points (PSAPs) 110, and increases the reliability of text to 911 services.

An internet protocol (IP) is used to manage all interconnections within the inventive solution. The present invention reduces reliance on time-division multiplexing (TDM) circuits 922.

The present invention may be used in combination with a short message service (SMS) or any kind of data transmission/messaging service.

The invention has particular applicability to emergency service providers, 3^{rd} party emergency services, public safety providers, and wireless carriers.

While the invention has been described with reference to the exemplary embodiments thereof, those skilled in the art will be able to make various modifications to the described embodiments of the invention without departing from the true spirit and scope of the invention.

What is claimed is:

1. A distributed emergency text message architecture, comprising:
an emedia aggregation gateway to receive an emergency text message initiated on an originating communications device; and
an emedia distribution server to convert said emergency text message, received from said emedia aggregation gateway, from an Internet protocol (IP) to a suitable message delivery protocol for delivery to a responsible recipient public safety answering point (PSAP) appropriate for a location of an emergency text messaging device initiating said emergency text message.

2. The distributed emergency text message architecture according to claim 1, further comprising:
an emedia message broker, in communication with said emedia aggregation gateway, to route said emergency text message to said emedia distribution server.

3. The distributed emergency text message architecture according to claim 1, further comprising:
an emedia local gateway to route said emergency text message to a teletype (TTY) terminal at said responsible public safety answering point (PSAP).

4. The distributed emergency text message architecture according to claim 1, wherein:
said emedia aggregation gateway, and said emedia distribution server modularly integrate over an internet protocol (IP) network to deliver said emergency text message to said responsible public safety answering point (PSAP).

5. The distributed emergency text message architecture according to claim 3, wherein:
said emedia local gateway is integrated with, and located at, said responsible public safety answering point (PSAP).

6. The distributed emergency text message architecture according to claim 1, wherein:
said emedia distribution server is located at said responsible public safety answering point (PSAP).

7. The distributed emergency text message architecture according to claim 1, wherein:
said emedia aggregation gateway is integrated within a servicing carrier network.

8. The distributed emergency text message architecture according to claim 1, wherein:
said suitable message delivery protocol is a teletype (TTY) protocol.

9. The distributed emergency text message architecture according to claim 1, wherein:
said suitable message delivery protocol is a hypertext transport protocol with secure sessions layer (HTTPS).

10. The distributed emergency text message architecture according to claim 1, wherein:
said suitable message delivery protocol is an internet protocol (IP).

11. The distributed emergency text message architecture according to claim 1, wherein:
said message recipient entity is a teletype (TTY) terminal.

12. The distributed emergency text message architecture according to claim 1, wherein:
said responsible PSAP receives said emergency text message at a web browser client.

13. The distributed emergency text message architecture according to claim 1, wherein:
said responsible PSAP receives said emergency text message via an emergency services Internet protocol (IP) network.

14. The distributed emergency text message architecture according to claim 1, wherein:
said emedia distribution server routes said emergency text message to said emedia local gateway to route to a teletype terminal (TTY) at said responsible public safety answering point (PSAP).

15. The distributed emergency text message architecture according to claim 1, wherein:
said emedia distribution server routes said emergency text message to said emedia local gateway to route to a web browser client at said responsible public safety answering point (PSAP).

16. A method for providing reliable text to 911 services, comprising:
receiving an emergency text to 911 message on an emedia aggregation gateway;
routing said emergency text to 911 message from said emedia aggregation gateway, via Internet protocol (IP), to an emedia distribution server;
converting said emergency text to 911 message from Internet protocol (IP) to teletype protocol (TTY); and
routing said emergency text to 911 message to a message recipient entity at said public safety answering point (PSAP).

17. The method for providing reliable text to 911 services according to claim 16, wherein said routing said emergency text to 911 message from said emedia aggregation gateway comprises:
routing said emergency text to 911 message via internet protocol (IP) from said emedia aggregation gateway to an emedia message broker; and
routing said emergency text to 911 message from said emedia message broker to said emedia distribution server.

18. The method for providing reliable text to 911 services according to claim 16, wherein:
said emergency text to 911 message is routed to an emedia local gateway at said public safety answering point (PSAP).

19. The method for providing reliable text to 911 services according to claim 6, wherein:
said text to 911 message is routed to an emergency services IP network at said public safety answering point (PSAP).

20. The method for providing reliable text to 911 services according to claim 17, wherein:
wherein said routing from said emedia message broker is location-based.
